(19) United States
(12) Patent Application Publication
(10) Pub. No.: US 2007/0033282 A1
(43) Pub. Date: Feb. 8, 2007

(54) Signaling redirection for distributed session and resource management

(76) Inventors: Weidong Mao, West Windsor, NJ (US); Charles L. Compton, Philadelphia, PA (US)

Correspondence Address: BROOKS KUSHMAN P.C., 1000 TOWN CENTER, TWENTY-SECOND FLOOR, SOUTHFIELD, MI, 48075, US

(21) Appl. No.: 11/198,986

(22) Filed: Aug. 8, 2005

(51) Int. Cl. G06F 15/173

(52) U.S. Cl. 709/226

(57) ABSTRACT

A system for on demand session and resource management in an on demand platform for the delivery of on demand digital assets involve a session manager, a plurality of resource managers, and a resource manager redirector. These components cooperate to provide a distributed and scalable system for on demand session and resource management. Redirection of session and resource signaling messages among various session and resource managers by the resource manager redirector allows the unavailability of devices or resources to remain transparent to the session manager. The resource manager redirector redirects messages from the session manager as appropriate.

### BACKGROUND OF THE INVENTION

1. Field of the Invention

The invention relates to on demand content delivery, including delivery of content including video, audio, programs, or data.

2. Background Art

The use of video on demand (VOD) has become widespread. For example, VOD is available in certain cable television (CATV) networks. To implement a video on demand platform it is necessary for the architecture to address resource allocation and to address on demand session management.

In one approach to on demand network architecture, network operators offer video on demand (VOD) services through interactive video systems that feature tight integration and customization across several system components, such as: asset management, session and resource management, billing and entitlement, network transport, and set top client applications.

In a more recent approach to on demand network architecture, an architecture for on demand session and resource management is proposed that is both distributed and scalable. This architecture is suitable for multiple interactive services serving multiple types of devices.

Background information pertaining to a distributed and scalable architecture for on demand session and resource management may be found in international patent application publication no. WO 2005/008419 A2.

In a distributed session and resource management architecture for on-demand service such as video on demand (VOD), resource manager selection and signaling among the various session and resource managers presents a challenge. One approach to addressing this challenge is to employ a centralized resource allocation model. This approach may become cumbersome with increasing demands for scalability, flexibility, and resource sharing among multiple services.

For the foregoing reasons, there is a need for an improved approach to resource manager selection and signaling among various session and resource managers in an on-demand network architecture.

### SUMMARY OF THE INVENTION

It is an object of the invention to provide improved methods and systems that provide signaling redirection for distributed session and resource management.

The invention involves architecture and functional flow for session and resource signaling redirection among various session and resource managers in a distributed on demand architecture. This approach can be applied to distributed session and resource management for on-demand services such as video on demand (VOD), network PVR, IP streaming, as well as other two-way interactive services. The architecture includes the on-demand client, session manager, resource managers, and resource manager redirectors.

A session set up message is requested by the on-demand client. The session manager collects a list of resource requirements for the session and chooses a list of resource managers to allocate underlying resources such as the streaming server, edge device, encryption engine, etc.

According to the invention, signaling is accomplished using the resource manager redirectors that interface, and redirect the messages from, the session manager to the correct resource managers. In a more general view, the invention comprehends allowing any components in the distributed on-demand architecture to redirect signaling messages based on the resource availability, load balancing, cost, and other criteria.

The invention implements the concept of a resource manager redirector for the selection of the resource managers and redirection of session and resource signaling messages among various session and resource managers. This solves problems and challenges associated with resource manager selection and signaling in a distributed session and resource management architecture for on-demand service such as video on demand (VOD), and provides many advantages over the legacy centralized resource allocation model in scalability, flexibility, and resource sharing among multiple services.

### BRIEF DESCRIPTION OF THE DRAWINGS

FIG. 1 describes the preferred reference architecture for on demand video services wherein signaling redirection is utilized for session and resource management;

FIG. 2 describes an example VOD deployment architecture;

FIG. 3 illustrates components and interfaces for NGOD Release 1;

FIG. 4 illustrates service discovery interfaces for NGOD Release 1;

FIG. 5 illustrates a multiple SRM hierarchy;

FIG. 6 illustrates an edge resource hierarchy;

FIG. 7 illustrates multiple on demand resource managers;

FIG. 8 illustrates an on demand resources hierarchy;

FIG. 9 illustrates segmented network connectivity;

FIG. 10 illustrates proposed SRM architectures;

FIG. 11 illustrates ERM discovery and selection; and

FIG. 12 illustrates ODRM discovery and selection.

### DETAILED DESCRIPTION OF THE PREFERRED EMBODIMENTS

1. Next Generation on Demand (NGOD) Reference Architecture

1.1 Overall Architecture

For the purpose of discussion, it is necessary to provide a reference architecture that includes all the key components and interfaces. The reference architecture described here provides a basic architectural framework describing the logical modules and interfaces as well as key functional flows.

1.1.1 Reference Architecture Description

The block diagram in FIG. 1 describes the proposed reference architecture for the next generation on demand video services. The initial focus of the architecture will be on the Video On Demand services but the architecture can be expanded to support other on demand services such as Switched Broadcast Video or networked PVR.

The reference architecture consists of a number of logical components and interfaces among them. The architecture and interfaces allow that single or multiple logical components be implemented in one physical module.

Logical Components

The architecture is partitioned functionally into a number of logical components. Each component is defined in such a way that the interchangeable module implementing the common interfaces can be introduced to work with the rest of the system. For example, multiple Streaming Servers can be introduced into the system as long as they implement the defined interfaces.

It is anticipated that in some cases, implementations may integrate several components into a single product or solution. This may potentially lower both capital and operational costs, as well as potentially increase the efficiency of the overall system. This integration does not mean that each of the logical components does not have to implement the relevant interfaces. For example, certain resource management components might be implemented in an integrated fashion with the session manager; in this case the relevant resource management interfaces must still be implemented and exposed.

Each logical entity described in the reference architecture may represent one or many physical entities in an actual implementation. For example, there may be multiple servers implementing the Session Manager (SM) for the purpose of load balancing and scalability.

The On Demand Client is typically located at the digital set-top box in the subscriber home. Any gateway server that is communicating with the other headend components on behalf of the digital set-top box will be considered as part of the On Demand Client. All other components are located at cable operators' master headend, secondary headend, or remote hub, depending on the specific deployment configuration and network topology. It would be preferable to have as much flexibility as possible in the placement of components, to accommodate the various physical deployment scenarios that exist in various divisions and regions. Gigabit Ethernet switching and transport greatly facilitates this, however interfaces need to be designed while keeping in mind that the physical location of various components vary in different deployment.

The key logical components include:
Asset Distribution System (ADS) (12)—distribute asset from content providers' or aggregators' premises to the network operators
Asset Management System (AMS) (14)—validate and manage life cycle of asset content and metadata
Real Time Source (RTS) (16)—capture real time contents such as those from real time encoder
Real Time Manager (RTM) (18)—manage real time source such as capturing schedule from a programming channel
Billing System (20)—manage customer billing and service subscriptions
Entitlement Server (ES) (22)—manage entitlement and transaction
Navigation Server (24)—present assets and service offerings and manage the navigation from the subscribers
Purchase Server (26)—validation purchase from the subscribers with the Entitlement Server, perform session authorization.
On Demand Client (28)—provide interfaces with on demand headend components and enable end user application. It may include any gateway server that serves as proxy of the set-top box
Asset Propagation Manager (APM) (30)—manage asset propagation across multiple streaming servers
On Demand Resource Manager (ODRM) (32)—manage resources required at the Streaming Servers
Streaming Server (SS) (34)—output video stream and manage stream control
Session Manager (SM) (36)—manage life cycle of session for on demand video services requested by subscriber
Conditional Access System (CAS) (38)—perform Conditional Access for the on demand video services
Encryption Resource Manager (40)—manage encryption configuration for each session
Encryption Engine (42)—perform encryption of video service associated with the session, can be located anywhere between video server and edge device
Network Resource Manager (NRM) (44)—manage resource required in the transport network for each session
Transport Network (46)—transport video services from server to edge
Edge Resource Manager (ERM) (48)—manage resource required at the edge for each session
Edge Device (50)—perform re-multiplexing and QAM modulation
Network Management System (NMS) (52)—provide network management for all the components in the headend
Data Warehouse (DW) (54)—provide reporting and analysis of data collected from on demand systems for data warehousing
Login Server (LS) (56)—collect logging data from various components for diagnosis and event tracing purposes.
   1.1.2 Interfaces

The main objective for the open architecture is to define and standardize the interfaces and protocols among various components. Both data and control plane interfaces need to be defined. An example of data plane interface is the transport protocol that carries on demand video content from Streaming Server to Edge Devices. An example of control plane interface is the resource signaling between Session Manager and On Demand Resource Manager.

In addition, management plane interfaces need to be defined in order to address the management of all the headend components in the architecture. Standard protocols such as SNMP (Simple Network Management Protocol) can be used for this purpose.

The key interfaces can be categorized as the following:
Asset Interfaces: A1 to A7, define asset management interfaces
Session Interfaces: S1 to S6, define session management interfaces
Resource Interfaces: R1 to R6, define resource management interfaces
Entitlement Interfaces: E1 to E2, define entitlement management interfaces
Stream Control Interface: C1, define stream control interfaces
Client Auto-Discovery Interface: D1, define client auto-discovery interfaces
Video Transport Interfaces: V1 to V4, define video transport formats from streaming server to edge
Network Management Interfaces: N, define network management interfaces
Data Warehousing Interfaces: W, define reporting interfaces with Data Warehouse.
Logging Interfaces: L, define event logging interfaces with Logging Server.
Service Discovery Interfaces: D, define service and resource discovery between various on demand components in the headend (not shown in the reference architecture diagram, to be described in Section 3).
   1.1.3 Deployment Configuration

In an actual deployment, a number of key decisions have to be made in the overall system configuration. As long as the functionalities and interfaces are consistent with those proposed in the reference architecture, one can use a variety of deployment configurations. For example, these may include:
Distributed or centralized deployment architecture (e.g. video servers, asset management systems, or Session Manager).
Native or middleware based approach
Network transport mechanism (e.g. Gigabit Ethernet, SONET)
Locations of various headend components (e.g. multiplexer, encryption engine, or QAM)
Application and business logic

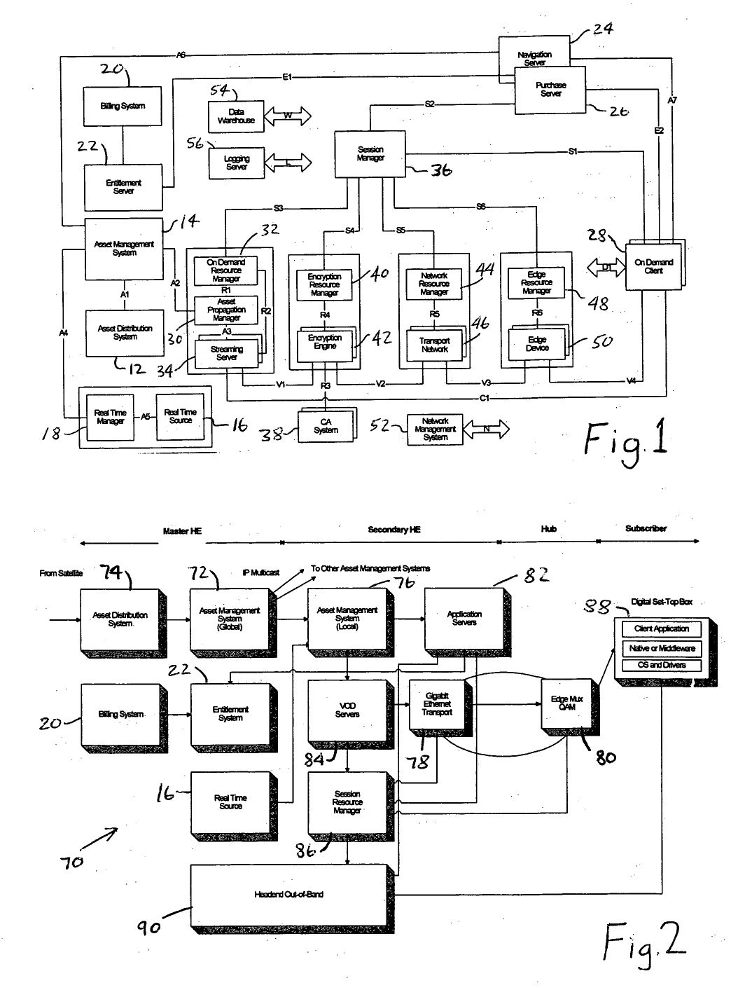

An example VOD deployment architecture 70 is described in FIG. 2. In this example, a global Asset Management System 72 is used at master headend to aggregate assets from the Asset Distribution System 74. It serves multiple local Asset Management Systems 76 at secondary headends. In addition, Gigabit Ethernet network transport 78 is used in conjunction with Edge QAM devices 80. Architecture 70 also includes Application Servers 82, VOD Servers 84, Session Resource Manager 86, Digital Set-Top Box 88, and Headend Out-of-Band (block) 90.

1.2 Logical Component Descriptions

1.2.1 Asset Distribution System (ADS) (12)

There are basically two types of asset: Content Asset and Metadata Asset. A Content Asset always has a Content File such as an MPEG file. A Content Asset has associated metadata that is intrinsic in describing the Content File such as coding format and bitrate. A Metadata Asset contains various type of the data that provide further information about the Content Asset such as ProviderID and AssetID as those defined in the CableLabs ADI 1.1 specification.

Asset Distribution System (ADS) is used to transport assets from content providers' or aggregators' premises to the cable operators' media center or headend.

Typically, the Asset Distribution System (ADS) contains one or multiple Pitchers that broadcast assets over a distribution network to multiple Catchers. Catcher will temporarily store the assets before they are transferred to the Asset Management System (AMS).

The other functionalities of ADS may include:
Multiple physical network support: satellite, IP backbone, etc.
Multiple transport support: broadcast, IP multicast, unicast, etc.
Private encryption schemes
Asset scheduling, updating, and reporting
   1.2.2 Asset Management System (AMS) (14)

The Asset Management System receives asset that include asset metadata and content files from Asset Distribution System using the Asset Distribution Interface (Interface A1). A number of processing steps will happen at the AMS. They may include:
Receiving and storing of assets
Asset metadata validation
Asset metadata modification
Asset life cycle management (create, modify, delete, etc.)
Delivering asset to Asset Propagation Manager (via Interface A2)
Publishing asset metadata to Navigation Server (via Interface A6)

In an actual deployment, multiple Asset Management Systems can be used to provide hierarchical asset management and propagation. For example, a global AMS can be deployed at cable operator's media center and interface with ADS. It will populate assets to several local AMS at the cable operator's headend. Interfaces such as IP multicast can be used between global and local AMS. For the purpose of this specification, the global or local AMS is treated as a single logical entity in the reference architecture.

It is desired that the AMS provides unified asset management to manage a variety of assets. These may include movies, HTML files, graphics, music, and real time contents such as those from the Real Time Source (RTS).

1.2.3 Real Time Source (RTS) (16) and Real Time Manager (RTM) (18)

In a typical VOD system, the video assets are pre-encoded and packaged before distribution through the Asset Distribution System. On the other hand, several services require that video is encoded real time or recorded from a Real Time Source (RTS) such as digital broadcast feeds at the cable operator's location. For example;
Free VOD service: broadcast video can be encoded at the cable operator's headend in real time
Networked PVR: analog broadcast programming can be encoded and captured. Digital broadcast programming can be recorded

The Real Time Manager (RTM) is defined as the component in managing the capturing operation of the Real Time Source (RTS) such as source identifiers, start and end time (via Interface A5). The metadata for the captured video is imported into the Asset Management System (AMS) from the Real Time Manager (RTM) (via interface A4). The video content file itself propagates from the Real Time Source (RTS) directly to the Streaming Server or other components as required directly via various unicast and/or multicast protocols.

1.2.4 Billing System (20)

There are several main functionalities of the billing system for on demand video services. They may include:
Subscriber information management
Subscription of services for each subscriber based on service definition and subscriber ID
Billing and transaction information collection

The proposed reference architecture uses the Entitlement Server (ES) to provide an interface abstraction layer to the billing system.

1.2.5 Entitlement Server (ES) (22)

The Entitlement Server (ES) provides interface abstraction layer between on demand system and cable operator's billing system. Typically, the ES will implement billing interfaces that integrate with the billing system. The ES then provides open interfaces to other components in the on demand architecture to enable entitlement and transaction management.

There are several main functionalities of the Entitlement Server:
Operators may provide to subscribers various on demand services each being uniquely identified with ID, description, etc. Each service may contain offerings of on demand contents with specific prices. The key part of the Entitlement Validation process is to answer the question of whether or not the subscriber is entitled to receive the Service and its associated Offerings.
Subscribers subscribe Services and purchase the Offerings through a variety of means. Subscriber will have to send the purchase request message to the Purchase Server that will perform entitlement check with the ES. The Purchase Server “knows” the relationships between particular Applications and Services. The Entitlement Validation process at the ES “knows” the relationships between particular Services and the set-top box/subscriber ID and other information such as Zip code.
If the subscriber is entitled and makes a specific purchase, the transaction is posted to the ES via the Purchase Server. The ES will then post the transaction to the billing system via billing interfaces. The ES is also responsible for other entitlement functions such as credit check.
   1.2.6 Navigation Server (24)

The reference architecture uses the Navigation Server as the logical entity to abstract application specific logic for asset navigation of on demand services. The Navigation Server obtains information necessary for the on demand application from other components, such as the asset metadata from the Asset Management System. The Navigation Server presents the navigation menu and related application features to the On Demand Client and exchanges messages with the On Demand Client to enable the navigation functions.

The Navigation Server needs to query and update the asset metadata from the AMS (via Interface A6). The timeliness of the asset status update is critical to a quality of end user navigation experience and the view of the asset list from each navigation server may vary based on criteria such as geographical location.

The Navigation Server may provide other application specific functionalities. For example, a Navigation Server can provide the following functions to the subscribers:
Menu, logo, and background images of application
Navigation of on demand content catalog, genre, etc.
VCR control bar for viewing of content
Parental control PIN management
“My Rental” list
   1.2.7 Purchase Server (26)

The reference architecture uses the Purchase Server as the logical entity to abstract application specific logic for purchase and authorization of on demand services. The Purchase Server obtains information necessary for the on demand application from other components, such as the subscriber entitlement information from the Entitlement Server. The Purchase Server receives the purchase requests from the On Demand Client and checks the Entitlement Server (ES) to enable the purchase authorization. Several key server side interfaces need to be defined. Specifically:

Entitlement interface: the Purchase Server needs to interface with Entitlement Validation process of the ES for authorization of the service (via Interface E1). The subscriber entitlement information that the Purchase Server retrieved from the ES may be cached to reduce latency.

Session authorization: the session signaling message from Session Manager needs to be sent to the Purchase Server for real time authorization of the session (via Interface S2). The completed session shall constitute a transaction that needs to be posted to the ES by the Purchase Server.

It is possible that the Navigation Server and Purchase Server are implemented in one combined module called the Application Server that may also provide other application functionalities. For the purpose of this specification, they are treated as separate logical components.

1.2.8 On Demand Client (28)

The On Demand Client is defined as a collection of the modules at the digital set-top box and/or any gateway server that may serve its proxy to communicate with the other NGOD components. The key messages and protocols between the On Demand Client and other NGOD components include:
Asset messages: query and update the list of assets and their metadata with the Navigation Server (via Interface A7)
Entitlement messages: request purchase authorization for a particular service offering with the Purchase Server (via Interface E2)
Session signaling protocols: session setup or teardown interfaces with the Session Manager (via Interface S1)
Stream control protocol: VCR control interfaces with the assigned Streaming Server (via Interface C1)
Client auto-discovery interfaces: Auto-discovery of the Edge QAMs that will serve the specific set-top box. (via Interface D1)

The specific interfaces within the On Demand Client such as those between the set-top box and any gateway/proxy server are not subject of this specification. They are usually optimized for different types of digital set-top boxes. For example, for low end set-top boxes with limited out-of-band channel, processor, and memory capacity, data carousel is commonly used to broadcast top asset lists and their metadata. Two-way asset query via out-of-band channel combined with in-band downstream channel may also be used. For set-top boxes with DOCSIS modem and more processor power and memory capacity, asset query via DOCSIS channel is more feasible.

1.2.9 Asset Propagation Manager (30)

The Asset Propagation Manager is responsible for managing the asset propagation from the various content sources such as AMS and RTS to the appropriate Streaming Servers (via Interfaces A3). This important function is sometimes called “Propagation Service”. The policy of the Propagation Service may be determined by a number of factors. For example:
Storage capacity: determine if there is enough storage for content files
Content duplication: determine whether the content needs to be duplicated in a distributed manner

The interface between Asset Propagation Manager and Streaming Server (Interface A3) is defined so that Streaming Servers from multiple vendors can be introduced to work within the same propagation service framework. It is essential that this interface hide the internal implementation of the storage system of the Streaming Server. The interface may include parameters such as the required storage capacity, ingest bandwidth, and whether to duplicate a content file to multiple Streaming Servers.

1.2.10 On Demand Resource Manager (32)

The On Demand Resource Manager is responsible for allocating and managing the streaming resources that are required from the Streaming Servers. Upon the session setup request from the client, the Session Manager (SM) will request resources from the On Demand Resource Manager (via Interface S3), in conjunction with the resources of other components in the overall system. The resources allocated by On Demand Resource Manager may include:
Selecting Streaming Server: This is based on the locations of the requested asset among the Streaming Servers that can be retrieved from the Asset Propagation Manager (via Interface RI)
Allocating streaming resource: This includes the allocation of the streaming resources of the selected the Streaming Server that contains the parameters such as streaming port and bandwidth (via Interface R2)
   1.2.11 Streaming Server (34)

The Streaming Server is responsible for streaming digital video to the digital set-top boxes using the Hybrid Fiber Coax network via the transport network and edge devices. In a typical system, large storage disk arrays are used to store MPEG video content with fault tolerance capability. The servers typically output MPEG-2 Single Program Transport Streams (SPTS) over UDP/IP and Gigabit Ethernet.

Typically, single or multiple Streaming Servers may be deployed across the network. Streaming Servers may be deployed at a centralized headend or at distributed remote hubs or both. The choices of deployment architecture can be driven by a number of factors such as operational feasibility, network transport availability, scalability, content caching and propagation, and the overall cost.

It is critical to define the architecture and interfaces in such a way that allows the introduction of new low cost and high performance video servers, leveraging future innovations in storage, networking, and content distribution technology. The architecture and interfaces shall enable the deployment of the Streaming Servers from multiple vendors within the same headend, serving the same client devices.

Typically, the Streaming Server also handles the VCR like stream control such as pause, fast forward, fast rewind etc. The trick mode files for contents can be generated ahead-of-time or on the fly by the Streaming Server.

1.2.12 Session Manager (SM) (36)

The Session Manager (SM) is responsible for managing the life cycle of sessions for on demand services.

On demand applications often require the establishment of sessions. A collection of server and network resources needs to be reserved for the session for certain duration of time. Typically, the SM will perform the following functions:
Communicate with the On Demand Client regarding session setup, session status, and session tear down
Interface with the corresponding Purchase Server to authorize the session requested by the subscriber
Allocate the resources required for the session by negotiating with the resource managers for appropriate server and network components
Dynamically add, delete, or modify the resources associated with the session to support integration of multiple on demand services
Manage the Quality of Service for the session
Manage the life cycle of the sessions

One of the main functions of the SM is to obtain required resources for the session by negotiating with resource managers of the relevant server and network components. They include:
Interface with On Demand Resource Manager to determine the Streaming Server resources such as asset location, allocated streaming server and output port, and source UDP/ IP parameters etc. (Interface S3)
Interface with Encryption Resource Manager to determine encryption resources required for the session. (Interface S4)
Interface with Network Resource Manager to determine the unidirectional path that will route the requested video stream to the edge devices covering the service group the subscriber resides. (Interface S5)
Interface with Edge Resource Manager to determine the resources used at the edge devices such as bandwidth required and MPEG tuning parameters so that the digital set-top box can tune to the MPEG program that carries the requested content. (Interface S6)

The Session Manager (SM) will need to negotiate with On Demand Resource Manager, Edge Resource Manager, and resource managers for other components to allocate resources to enable streaming video from any server to any edge. For example, the asset files may not be available in the streaming server that is connected to the identified network path to the subscriber. An alternate server and network path may have to be used. Therefore, the SM will need to negotiate with the On Demand Resource Manager and other resource managers to reconcile the differences.

Multiple types of the Session Managers may be used while sharing the same Resource Managers and underlying resources. This will allow the Session Manager to be further optimized for variety of applications. For example:
Interactive Session Manager can be used to manage interactive sessions such as those used in VOD
Switched Broadcast Session Manager can be used to manage sessions used in Switched Broadcast Video services
   1.2.13 Conditional Access System (CAS) (38)

The Conditional Access System (CAS) is responsible for the overall security of the on demand video services. In addition to supporting the legacy CAS already deployed in the field, the architecture shall allow introduction of new CAS in the same or different headends.

In a typical Conditional Access System (CAS), the encryption of digital services can be achieved by using the Entitlement Control Messages (ECM) and Entitlement Management Messages (EMM). ECMs are used to secure the control words that are required to scramble the packets. EMMs are used to enable specific users to retrieve ECMs that are required to decode the control words and de-scramble the packets.

Open interfaces are required on the CAS to enable the access of ECMs and EMMs as well as other configuration information.

In case of pre-encryption, ECMs/EMMs are generated in such a manner to enable a group of digital set-top boxes to access content that has been pre-encrypted and stored at the server ahead of time. In case of real time encryption (tier or session based), ECMs/EMMs are generated and assigned to a particular session. The content has to be scrambled on the fly at the Encryption Engine based on the ECMs generated by the CAS.

Whether the content needs to be encrypted may be determined by a number of factors. Content providers can require the asset to be encrypted by enabling the “Encryption” field in the corresponding asset metadata file as defined by Content Specification 1.1. Network operators can also require the specific service to be encrypted. In addition, the system shall be able to identify which CA system to encrypt the content in case of multiple CAS headend.

There are a number of ways that ECMs/EMMs can be transmitted to the digital set-top box. For example, they can be transmitted in the corresponding MPEG in-band channels, or transmitted via the out of band channels.

1.2.14 Encryption Resource Manager (40)

The Encryption Resource Manager is responsible for managing the Encryption Engines and provisioning the encryption resources required by sessions (via Interface R4). These Encryption Engines may be located anywhere from the server to the edge.

The Encryption Resource Manager plays a central role in the case of real time encryption (tier or session based) as well as pre-encryption.

1.2.15 Encryption Engine (42)

The Encryption Engine performs real time encryption of the MPEG-2 packets carrying on demand content. It can be located anywhere between Streaming Servers and edge devices. For example, the encryption engine may be embedded in the multiplexer or edge QAM devices.

In order to perform the real time encryption (tier or session based), the Encryption Engine needs to retrieve the appropriate parameters such as the ECMs (via Interface R3) from the corresponding CA system.

1.2.16 Network Resource Manager (44)

The Network Resource Manager is responsible for allocating and managing the resources that are required in the transport network (via Interface RS). In other words, the Network Resource Manager needs to identify a unidirectional route that transports the digital video stream from the server to the edge devices covering the right service group and traversing the required set of network resources. To enable distributed network resource allocation, network resource management functionality is divided into two logical functions that are implemented in different components. The two logical functions are network resource monitoring and network resource allocation. Network resource monitoring is a function that provides information on the connectivity and available network bandwidth between data plane components while network resource allocation reserves network bandwidth between data plane components. The network resource monitoring function is implemented in a component called the Network Resource Monitor while network resource allocation is implemented in resource managers in NGOD release 1 and the IP transport network itself in future release.

1.2.17 Transport Network (46)

Transport Network is used to transport video streams from the Streaming Server to the Edge Device, potentially via a number of network devices such as encryption engines. Depending on the implementation, a variety of Transport Networks can be used to carry video streams such as Gigabit Ethernet and ATM/SONET; in all cases the video is carried over the transport network using IP packets. The current prevailing technology is to use IP infrastructure via Gigabit Ethernet. Typically, the requested content is carried over the MPEG SPTS (Single Program Transport Stream) and mapped over UDP/IP at the output of the Streaming Server. Gigabit Ethernet switches and/or routers can be used to transport the stream to the right Edge Device based on the configuration from the Network Resource Manager.

1.2.18 Edge Resource Manager (48)

The Edge Resource Manager is responsible for allocating and managing the resources that are required at the Edge Devices such as QAM bandwidth (via Interface R6).

Typically, the Edge Resource Manager needs to allocate specific QAM resource from the Edge Device that can serve the requested set-top box. Upon the resource request from Session Manager for a specific session, the Edge Resource Manager needs to determine the Edge Device to use, input UDP port and IP address, as well as output frequency and MPEG program parameters. Other functionalities of the Edge Resource Manager may also include the bandwidth management and quality of service. For example, in order to support dynamically added content to an existing session, the edge bandwidth may need to be added to the session offered from the same QAM.

1.2.19 Edge Device (50)

The main functions of the Edge Device are to receive the multiple MPEG SPTS carried over UDP/IP from IP transport network, multiplex into MPEG MPTS, and generate QAM modulated signals. The other features of Edge Devices may include:
MPEG PID remapping
PCR (Program Clock Reference) re-stamping
Statistical multiplexing
Rate Shaping
Multicast switching (e.g. for Switched Broadcast)
   1.2.20 Network Management System (NMS) (52)

The Network Management System (NMS) is responsible for managing the headend components described in the architecture. Management includes fault detection, status monitoring, and configuration. Commonly used protocols such as SNMP can be used where the appropriate MIBs need to be defined for these interfaces.

Event logging for the key NGOD components can be provided to enable further detailed diagnosis and analysis in various error situations.

1.2.21 Data Warehouse (DW) (54)

The Data Warehouse (DW) is responsible for collecting, analyzing, and reporting of the on demand statistical data retrieved from various components in the architecture such as Session Manager and various Resource Managers.

1.2.22 Logging Server (LS) (56)

The Logging Server (LS) is responsible for collecting event logging data from various components in this architecture. It is used to provide detailed logs of on demand session and resource signaling messages for purposes of diagnosis and event tracing.

2 Interface Description

The interfaces identified in the reference architecture are to be defined in an open, non-proprietary fashion to facilitate multi-vendor environments for deploying on demand services.

These interfaces may belong to one of the following three categories:
Interfaces that can use existing standards wherever they apply
Interfaces that require modification or extension of existing standards
Interfaces that require new specifications to be proposed and adopted
   2.1 Asset Interfaces

The asset related interfaces include Interfaces A1 to A7. They are primarily responsible for managing or navigating the asset metadata and content. In addition, they are also responsible for monitoring the status of assets.

2.1.1 Asset Distribution Interface (A1)

The Asset Distribution Interface between the Asset Distribution System (ADS) and the Asset Management System (AMS) is responsible for distributing content and metadata files from the ADS to the AMS. As defined in the CableLabs Asset Distribution Interface version 1.1 (ADI 1.1), an asset can be uniquely identified by the combination of Provider ID and Asset ID. There are also on going discussions of ADI 2.0 that introduces the concept of Collection. The content format for VOD has been defined in the CableLabs Content Specification version 1.1.

2.1.2 Asset Ingest Interface (A2) The Asset Ingest Interface between the Asset Management System and the Asset Propagation Manager is responsible for managing the asset ingestion from the AMS to the Asset Propagation Manager and/or the Streaming Server(s). In addition, this interface can provide additional features such as query of the asset status and deletion of the asset.

2.1.3 Asset Propagation Interface (A3)

The Asset Propagation Interface between the Asset Propagation Manager and the Streaming Server(s) is responsible for managing the propagation of the asset to the Streaming Server(s).

The Asset Propagation Manager applies certain rules to determine where a content file is to be propagated to. These rules may be determined from the popularity, content duplication and caching, as well as the storage characteristics. The interface needs to be specified to allow the Asset Propagation Manager to retrieve necessary information from the Streaming Server such as storage availability, load, and ingest bandwidth, etc.

2.1.4 Real Time Metadata Interface (A4)

The Real Time Metadata Interface between the Real Time Manager and the Asset Management System is responsible for collecting the metadata describing the content from a Real Time Source.

2.1.5 Real Time Manager Interface (A5)

The Real Time Manager Interface between Real Time Manager (RTM) and Real Time Source (RTS) is responsible for managing the capturing of the real time contents by the RTS such as the source identifier, start and end time etc. RTM will need to retrieve programming listing information from a guide data provider.

2.1.6 Asset Publishing Interface (A6)

The Asset Publishing Interface between the Asset Management System and the Navigation Server is responsible for publishing the asset list and metadata as well as other content data needed for navigation (e.g. poster art) from the AMS to the Navigation Server or any other application components.

This interface shall address add, delete, and modify of the asset list and metadata. In addition, it shall also update the status of assets.

2.1.7 Client Navigation Interface (A7)

The Client Navigation Interface between the On Demand Client and the Navigation Server is responsible for enabling navigation of the asset list and metadata offered by the Navigation Server. The On Demand Client will perform asset query based on the application flow. Any gateway server that performs asset query on behalf of the digital set-top box shall be considered as part of the On Demand Client for the purpose of this specification.

One option for this interface is to leverage standard Web interfaces based on Extensible Markup Language (XML) and Extensible Stylesheet Language (XSL) technology. XSL can be used to transform the XML metadata to the format that can be used by a variety of On Demand Client.

2.2 Session Interfaces

The session related interfaces include Interfaces S1 to S6. They are primarily responsible for session setup and teardown as well as other session management functions. They are highly real time in nature. Therefore, performance issues such as latency and throughput shall be taken into consideration in the interface design.

In general, two standard suites are available and widely used for session protocols: DSM-CC and RTSP. The MPEG Digital Storage Media—Command and Control (DSM-CC) user to network protocols can be used for session setup, teardown, and other related session signaling messages. These protocols typically run over TCP/IP. A subset of DSM-CC has been adopted and several extensions have been made in the Session Setup Protocol (SSP) specification. The Real Time Streaming Protocol (RTSP) is a standard proposed in the IETF, initially addressing real time streaming media over IP but extendable to support HFC network. RTSP is based on the format very similar to HTTP.

The DSM-CC and RTSP approaches differ in industry acceptance, performance, and flexibility. The NGOD specification adopts a hybrid of both approaches depending on the specific interfaces. Any new approach will also be considered if it has significant advantages compared with these two existing approaches.

2.2.1 Client Session Interface (S1)

The Client Session Interface between the On Demand Client and the Session Manager is responsible for signaling messages to/from the On Demand Client. They include client session setup, client session teardown, and other client session management functions such as session heartbeat. Any gateway server that performs session signaling on behalf of the digital set-top box shall be considered as part of the On Demand Client for the purpose of this specification.

2.2.2 Session Authorization Interface (S2)

The Session Authorization Interface between the Session Manager and the Purchase Server is responsible for authorizing the session requested by the On Demand Client.

In addition, it provides a play list of assets identified by ProviderID and AssetID for the specific session request from the On Demand Client. It also provides resource requirements for the session such as bitrate, codec, and encryption related parameters.

2.2.3 Session and On Demand Resource Interface (S3)

The Session and On Demand Resource Interface between the Session Manager and the On Demand Resource Manager is responsible for negotiating resources required at the Streaming Server for the requested session.

The parameters involved may include the a play list of ProviderID and AssetID in the request message, assigned Streaming Server and its output port, source UDP/IP parameters in the response message, etc.

2.2.4 Session and Encryption Resource Interface (S4)

The Session and Encryption Resource Interface between the Session Manager and the Encryption Resource Manager is responsible for negotiating resources required at the Encryption Engine for the requested session.

The parameters involved may include the UDP Port and IP address of the encrypted stream and the CA system ID, etc.

2.2.5 Session and Network Resource Interface (S5)

The Session and Network Resource Interface between the Session Manager and the Network Resource Manager is responsible for negotiating resources required at the Transport Network for the requested session.

The parameters involved may include the UDP Port and IP address of the selected Streaming Server and Edge Devices in the request message, assigned transport network resources in the response message, etc.

2.2.6 Session and Edge Resource Interface (S6)

The Session and Edge Resource Interface between the Session Manager and the Edge Resource Manager is responsible for negotiating resources required at the Edge Device for the requested session.

The parameters involved may include any fields indicating the requested subscriber's accessible QAM identifiers in the request message, allocated edge QAM to use and frequency and MPEG tuning parameters in the response message, etc.

2.3 Resource Interfaces

The resource related interfaces include Interfaces R1 to R6. Various resource managers use these interfaces to manage the resources of the corresponding components. These interfaces shall allow the resource manager to retrieve configuration, topology, status, and resource availability of the corresponding components. The resource interfaces are typically running in parallel with each other and do not have to be synchronized with the session interfaces.

2.3.1 Asset Location Interface (R1)

The Asset Location Interface between the On Demand Resource Manager and the Asset Propagation Manager is responsible for allocating the Streaming Server to stream the requested asset. In this model, it is assumed that the Asset Propagation Manager maintains a table of asset and its location(s) on the Streaming Server(s). It will return to the On Demand Resource Manager the location(s) of the Streaming Server(s) that can stream the requested asset.

2.3.2 Streaming Server Resource Interface (R2)

The Streaming Server Resource Interface between the On Demand Resource Manager and the Streaming Servers is responsible for managing the resources of the Streaming Servers. Through this interface, the On Demand Resource Manager will monitor configuration, status, and resource availability of the multiple Streaming Servers. It will use this information to, among other things, make sure that the Streaming Server(s) identified to stream an asset via the Asset Location Interface (R1) is available and has enough bandwidth capacity to stream the asset.

2.3.3 Conditional Access System Interface (R3)

The Conditional Access System Interface between the Conditional Access System and the Encryption Engine is responsible for retrieving appropriate conditional access messages such as ECM for the Encryption Engine to encrypt a requested session. The Encryption Engine may use identification such as CA System ID to choose the specific CA system to encrypt the session in a multiple CA environment. As a further optimization, the Encryption Engine may request and cache multiple ECMs from the CA system to be used for upcoming sessions.

2.3.4 Encryption Resource Interface (R4)

The Encryption Resource Interface between the Encryption Resource Manager and the Encryption Engine is responsible for managing and allocating encryption resources. Through this interface, the Encryption Resource Manager will monitor configuration, status, and resource availability of the multiple encryption engines. It will choose the appropriate encryption engine for each session based on current encryption engine availability, type of encryption required, and other factors.

2.3.5 Network Resource Interface (R5)

The Network Resource Interface between the Network Resource Manager and the Transport Network is responsible for managing and allocating transport network resources. Through this interface, the Network Resource Manager will monitor configuration, status, and resource availability of the multiple components in the transport network path, such as a Gigabit Ethernet Switch(es). It will also reserve appropriate bandwidth resources in the selected network path. Standards such as those defined in IETF have already addressed some of these issues. NGOD specifications will leverage standard IP networking protocols for this interface with minimum modifications, where appropriate. As stated before, the Network Resource Manager is composed of Network Resource Monitor and Network Resource Allocation. If only the Network Resource Monitor is used, the interface R5 will not be required.

2.3.6 Edge Resource Interface (R6)

The Edge Resource Interface between the Edge Resource Manager and the Edge Device is responsible for managing and allocating edge resources. Through this interface, the Edge Resource Manager will monitor configuration, status, and resource availability of the multiple edge devices. It is assumed that the Edge Resource Manager maintain the resource inventory and status of the Edge Devices it manages. It will choose the appropriate edge device and QAM in addition to the tuning information such as the frequency and MPEG program.

2.4 Entitlement Interfaces

The Entitlement Interfaces including Interfaces E1 to E2 are responsible for performing entitlement validation, purchase authorization, and transaction posting through the Entitlement Server (ES).

2.4.1 Entitlement Validation Interface (E1)

The Entitlement Validation Interface between the Purchase Server and the Entitlement Server is responsible for performing entitlement checks. It will require subscriber ID and the service being purchased. To further optimize performance, it is possible that the Purchase Server will cache the result of the entitlement check as long as the Entitlement Server provides the expiration time for each entitlement. This is so that when the session manager requests an authorization via interface S2, the Purchase Server will be able to answer the request without going back to the Entitlement Server.

2.4.2 Client Purchase Interface (E2)

The Client Purchase Interface between the On Demand Client and the Purchase Server is responsible for performing purchase authorization check for the selected service offering. Any gateway server that communicates with the Purchase Server on behalf of the digital set-top box is considered as part of the On Demand Client for the purpose of this specification. Through this interface, the On Demand Client will send purchase request messages to the Purchase Server. The Purchase Server will be responsible for determining if the subscriber is authorized to purchase the selected service by either checking the cached result or performing an entitlement check as described in the Entitlement Validation Interface. The Purchase Server will send the purchase response message to the On Demand Client indicating whether the purchase is authorized or not.

2.5 Stream Control Interfaces

The Stream Control Interface (Cl) supports VCR like “trick modes” such as play, pause, fast forward, and reverse. Like session management, the interface may either adopt DSM-CC or RTSP standard.

In the DSM-CC case, the DSM-CC user-to-user specification has been adapted as the Lightweight Stream Control Protocol (LSCP). In the RTSP case, it provides the stream control in the HTTP like common framework.

Typically, the stream control messages are handled directly by the Streaming Server to ensure the low latency.

2.6 Client Auto-Discovery Interfaces (D1)

The Client Auto-discovery Interfaces (D1) are responsible for allowing the On Demand Client to discover its own location in the transport distribution network (HFC) automatically and to report back to headend component periodically.

Various schemes have been proposed. For example, the client can auto-discover using a set of unique MPEG Transport Stream IDs assigned by the Edge QAM that the set-top can see.

2.7 Video Transport Interfaces

The Video Transport Interfaces including Interfaces V1 to V4 are responsible for delivering on demand contents.

2.7.1 Source Transport Interface (V1)

The Source Transport Interface specifies the protocol used to carry on demand streams at the output of the Streaming Server. For Gigabit Ethernet outputs, the mapping of MPEG-2 Single Program Transport Stream (SPTS) over the UDP/IP is used.

2.7.2 Encrypted Transport Interface (V2)

The Encrypted Transport Interface specifies the protocol used to carry on demand streams that have been encrypted by the appropriate encryption engine.

Typically, MPEG-2 Single Program Transport Stream is encrypted and carried over UDP/IP. MPEG-2 transport protocol may be used to specify where to carry ECMs/EMMs if they are delivered in the stream.

2.7.3 Network Transport Interface (V3)

The Network Transport Interface defines the protocol used to carry on demand streams in the core IP network from the server to the edge, before or after the encryption. For Gigabit Ethernet outputs, the mapping of MPEG-2 Single Program Transport Stream (SPTS) over the UDP/IP is typically used.

2.7.4 Client Transport Interface (V4)

The Client Transport Interface defines the protocol used to carry on demand streams at the output of edge devices such as QAM modulators and CMTSs. MPEG-2 Multiple Program Transport Stream (MPTS) over QAM is typically used for QAM modulators. It is possible that the additional data content are encoded in the MPEG format and delivered in-band to the digital set-top box.

2.8 Network Management Interfaces

The Network Management Interfaces (N) between the Network Management System and all the components in the proposed architecture are responsible for the overall network management functions. The Simple Network Management Protocol (SNMP) is commonly used for the Network Management Interfaces.

The Network Management Interfaces are primarily intended to interface with an external Network Management System. NGOD defines a common set of MIBs applicable for all the key components and specific sets of MIBs that are unique for each individual component.

NGOD also standardizes common event logging format for various components to enable further detailed diagnosis and analysis in various error situations.

2.9 Data Warehousing Interfaces

The Data Warehousing Interfaces (W) between the Data Warehouse and relevant components in the reference architecture are responsible for the collection of the data using a common defined format. This interface can be applicable to various NGOD components such as Session Manager, Edge Resource Manager, and On Demand Resource Manager.

2.10 Event Logging Interfaces

The Event Logging Interfaces (L) between the Logging Server and relevant components in the reference architecture are responsible for the collection of the logging event using a common defined format. This interface can be used for the logging of session and resource signaling events from Session Manager and various Resource Managers.

2.11 Service Discovery Interfaces

The Service Discovery Interfaces (D) between the various headend components are responsible for the service and resource discovery. These interfaces are running asynchronous from the session and resource signaling interfaces. These interfaces will be described further in Section 3.

3 Architecture Recommendations for Release 1

3.1 Overview

This section provides detailed recommendations on key architectural issues for the Release 1 of next generation on demand specification. The recommendations are developed based on the following approaches:
Detailed analysis on technical options and tradeoffs
Provide key architecture design choices:
Meet high level requirements and is consistent with overall architecture
Optimized for most likely system configurations
Work for corner cases (may not be optimal) It is recognized that there may be several possible solutions to each of the architectural issue. The general approach being taken for Release 1 of the Next Generation On Demand specification is to lay down the architectural foundation for the current and future releases while selecting a specific set of interfaces. In the future releases, the specific interface protocols may be allowed to change but the architecture remains the same.
   3.2 Release 1 Architecture Configurations

The Next Generation On Demand (NGOD) architecture described in the previous sections offers a very flexible model for various on demand applications. Release 1 of the NGOD has a narrower scope. This section will describe the overall Release 1 architecture configuration.

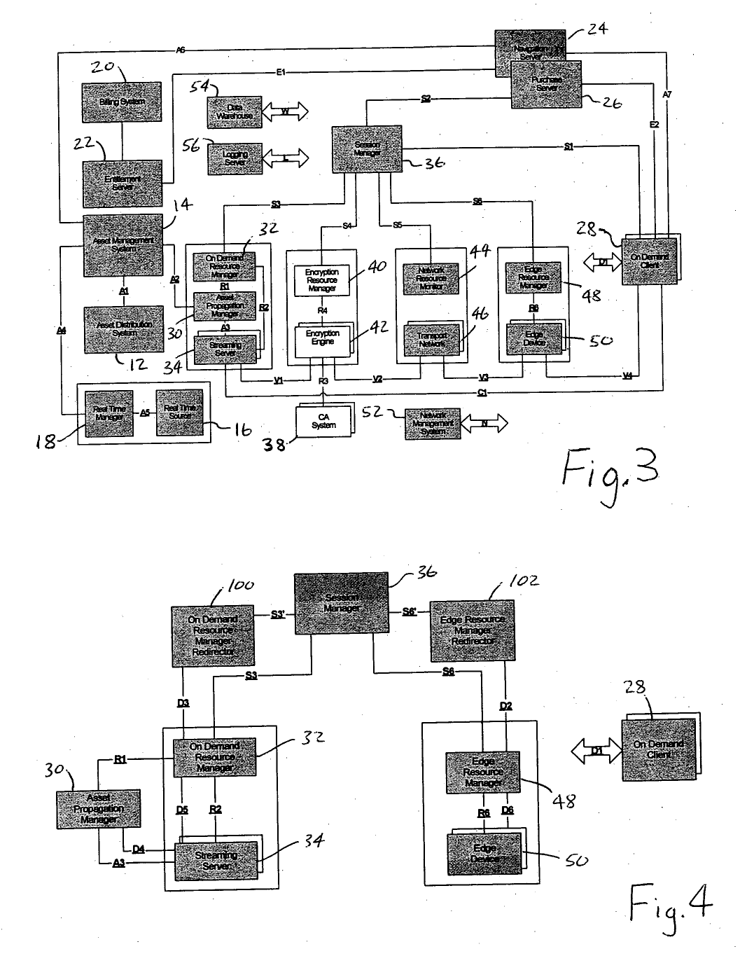

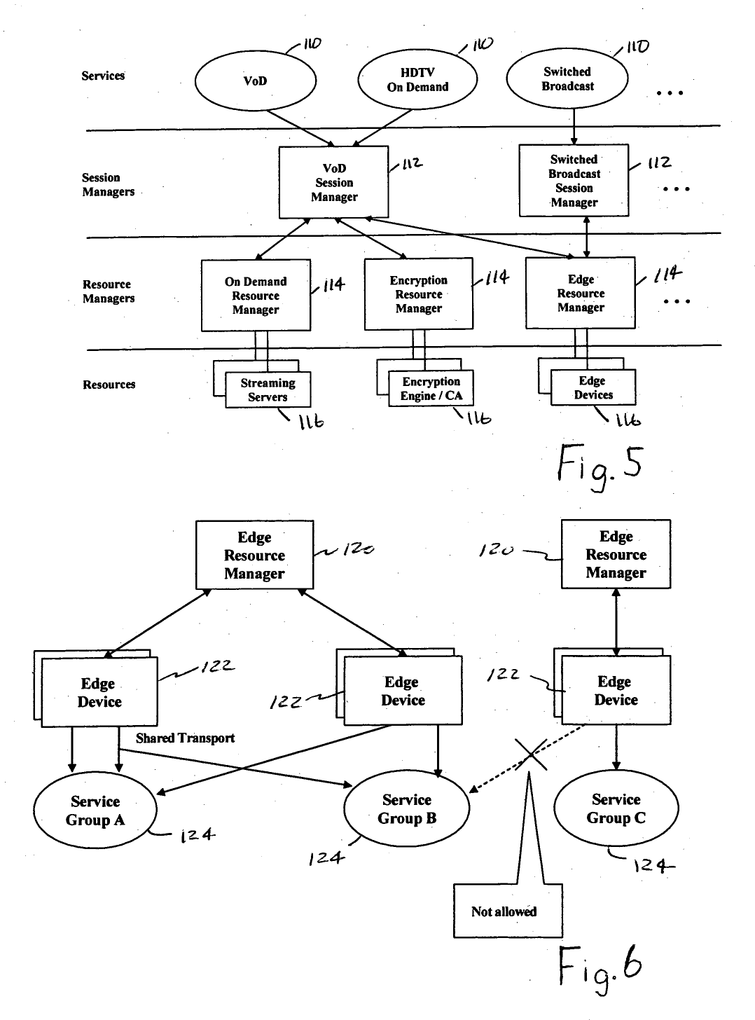

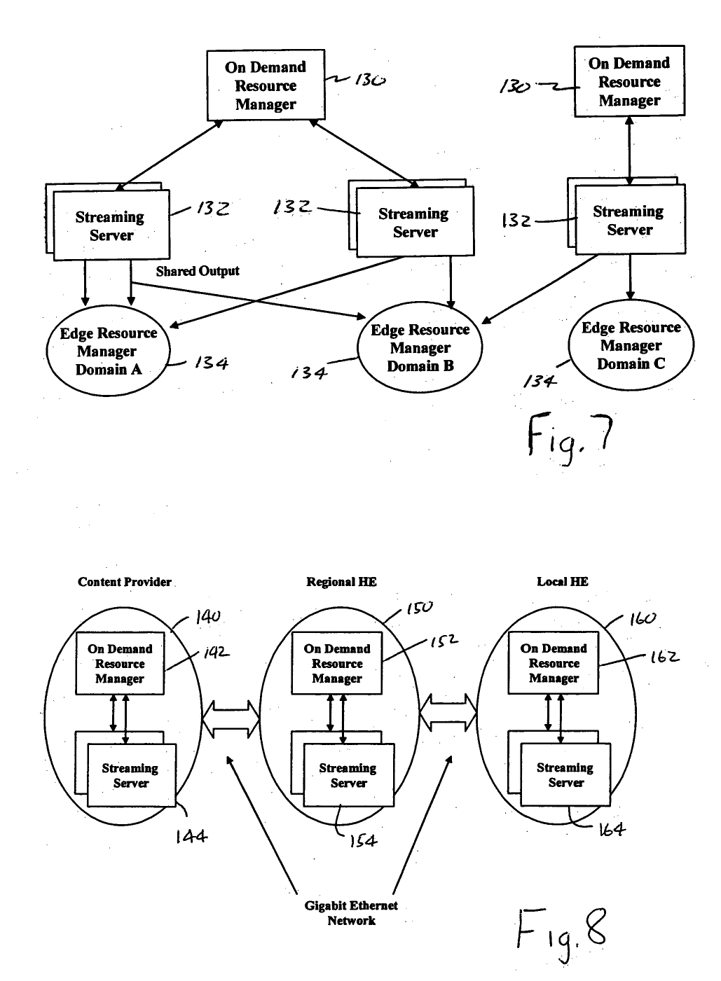

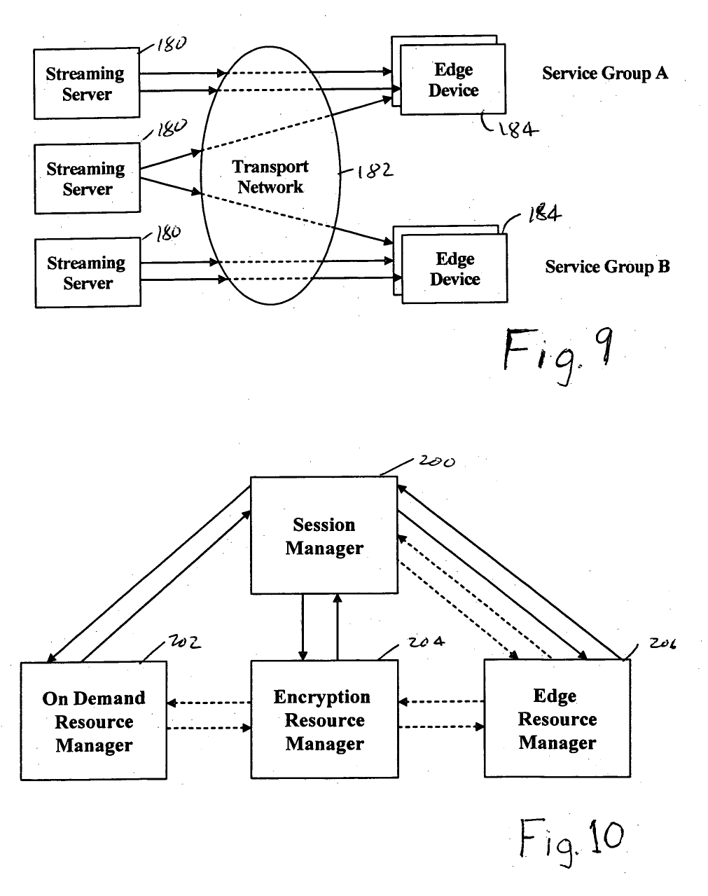

The components and interfaces specified for NGOD Release 1 are shown in FIG. 3 marked on the NGOD reference architecture. In addition to these interfaces, it should be noticed that the interfaces with the Encryption Resource Manager are defined for the pre-encryption model as described in the later section. Furthermore, as shown in FIG. 4, the service discovery interfaces (D) are also specified for NGOD Release 1 along with Edge Resource Manager Redirector (ERMR) 102 and On Demand Resource Manager Redirector (ODRMR) 100. More details will be described in later sections.

3.2.1 Key Notations

The following notations are used when describing the Release 1 architecture configuration:
“Single” entity means “Single Logical” entity
“Multiple” entities means “Multiple Logical” entities
One or multiple physical machines can be used to implement each logical entity
   Support scalability and load balancing
   Support high availability with maintenance window
   Support redundancy for fail-over
      3.2.2 Typical Architecture Configuration

In general, the Release 1 assumes following architecture configurations.

Asset Management and Propagation

There are multiple Regional Asset Management Systems (RAMS) each serving one or multiple headend and hub
Each RAMS can manage metadata assets and propagate content assets to multiple Streaming Servers under the direction of Asset Propagation Managers (APM)
Each APM can manage the propagation of assets into the Streaming Servers controlled by multiple On Demand Resource Managers (ODRM)
   Edge Resource Manager (ERM)
There are multiple ERMs
Each ERM and its Edge Devices serve one or multiple service groups
Each service group is managed by a single ERM (better bandwidth management and less complex)
Each QAM in an Edge Devices can serve single service group (dedicated) or multiple service group (shared)
   On Demand Resource Manager (ODRM)
There are multiple ODRMs
Each ODRM and its Streaming Servers serve one or multiple service groups
Multiple ODRM/Streaming Servers can serve a single service group (allow hierarchical and distributed server architecture)
   Session Managers and Application Servers
Multiple services (e.g. VoD, HD-VOD) can share a single logical session manager simultaneously
Multiple logical session managers can perform different sets of functions and/or protocols optimized for different applications:
   Interactive session manager
   Broadcast session manager
   Multiple logical session managers may be combined into a single entity in the actual physical implementation.
Resource managers and underlying resources can be shared by multiple session managers simultaneously

The separation of the Session Managers, Application Servers (e.g. Navigation/Purchase Server), and Resource Managers in the Next Generation On Demand architecture will allow multiple session managers sharing the common resource managers and underlying resources. It provides the potentials of stimulating innovations and service expansion in a multi-vendor session and resource manager environment.

FIG. 5 illustrates a multiple SRM hierarchy, including Services 110, Session Managers 112, Resource Managers 114, and Resources 116.

3.2.3 Edge Resource Hierarchy

Edge Resource Manager Domain: it belongs to a single Edge Resource Manager that manages the Edge Devices serving one or multiple service groups. It is also called the “QAM Group”.
Within an Edge Resource Manager Domain (QAM Group):
   Each Edge Device can serve multiple service groups with multiple QAM outputs
   Each QAM output can be shared by multiple service groups simultaneously
Each Edge QAM can only be managed by one Edge Resource Manager
Each Service Group can only be served by a single Edge Resource Manager (simplify SRM flow and better bandwidth management)

It is recommended to support a single Edge Resource Manager per service group. Multiple service groups may share a single Edge Resource Manager.

FIG. 6 illustrates an edge resource hierarchy, including Edge Resource Managers 120, Edge Devices 122, and Service Groups 124.

3.2.4 On Demand Resource Hierarchy

On Demand Resource Manager Domain: it belongs to a single On Demand Resource Manager that manages the Streaming Servers serving one or multiple Edge Resource Manager Domains (QAM Groups). On Demand Resource Domain is also called “SOP Group” or “Server Output Port Group”
When an ODRM domain (SOP Group) serves an ERM domain (QAM Group), the Streaming Servers within the ODRM domain may or may not have any to any network connectivity to the Edge Devices within the ERM domain (QAM Group).
Within an On Demand Resource Manager Domain (SOP Group):
   Each Streaming Server can serve multiple Edge Resource Manager Domains (QAM Groups) with multiple GigE outputs
   Each GigE output can be shared by multiple Edge Resource Manager Domains (QAM Groups) simultaneously
Each Streaming Server can only be managed by one On Demand Resource Manager
Each Edge Resource Manager Domain (QAM Group) can be served by multiple On Demand Resource Domains (SOP Groups)
It is recommended to support multiple On Demand Resource Managers for each Edge Resource Manager Domain (QAM Group).

FIG. 7 illustrates multiple on demand resource managers, including On Demand Resource Managers 130, Streaming Servers 132, and Edge Resource Manager Domains 134.

Hierarchical Server System

Multiple logical clusters of Streaming Servers may be located in regional HE and local HE. They can serve one or multiple Edge Resource Manager Domains via GigE transport network. The storage system may be multi-tiered with Library Server and Streaming Server storage. The architecture configuration can support distributed, heterogeneous architecture with multiple logical clusters, where storage/streaming resource may be distributed among Regional HE, Local HE, Hub, or Content Provider's site.

The advantage of using the above hierarchical, multi-tier server architectures in Release 1 will allow the introductions of the so called library server (also an ODRM domain) where all the contents will be stored with large storage capacity. The contents will not need to be replicated in each of the streaming servers in each ODRM since only the most popular contents will need to be propagated to the regional or local streaming servers. Depending on the network topology, asset availability, server load, and other factors, an ODRM domain will be chosen.

FIG. 8 illustrates an on demand resources hierarchy, including Content Provider 140 having On Demand Resource Manager 142 and Streaming Servers 144, Region HE 150 having On Demand Resource Manager 152 and Streaming Servers 154, and Local HE 160 having On Demand Resource Manager 162 and Streaming Servers 164.

3.2.5 Network Connectivity and Role of Network Resource Management

In the most general case of IP network connectivity between Streaming Servers and Edge Devices, the network topology is segmented instead of any to any. Therefore, it is recommended to support the segmented network connectivity NGOD Release 1.

For the segmented network, connectivity, reliability, and QoS of network resources may require network resource management. There are typically two scenarios:
Static: If the mapping of server outputs to edge devices are configured and known a priori, and network is reliable and under-subscribed, the Network Resource Manager may be simplified by using the Network Resource Monitoring functions only.
Dynamic: it is needed to establish network link dynamically based on the network resource availability, reliability, and QoS (e.g. using RSVP), Network Resource Manager with dynamic capability is needed.

For NGOD Release 1, the usage of the “Network Resource Monitor” from the Network Resource Manager to support over-provisioned and segmented network in the above static approach is recommended. It has the following functions:
Maintain static IP end point connectivity
Leave On Demand Resource Manager to manage the bandwidth at Streaming Server outputs
Can be implemented as a stateless component and does not maintain session state
Allow any component may interface to Network Resource Monitor

In the Release 1, the transport network bandwidth is provisioned more than the total QAM bandwidth.

FIG. 9 illustrates segmented network connectivity, including Streaming Servers 180, Transport Network 182, and Edge Devices 184.

3.3 Session and Resource Manager (SRM) Architecture

The high level model that support the Next Generation On Demand (NGOD) architecture for Session Manager and Resource Managers are based on the following design goals for Release 1:
Support logical separation of session manager and resource managers
Support distributed on demand server clusters
Balance the complexity of session and resource managers
Allow high throughput and low latency
Optimize architecture and interface for most likely configurations
Support various system topologies
Provide flexibility for future extensions
   3.3.1 Recommended SRM Architecture Models

FIG. 10 represents the two proposed SRM architectures models: Hub and Spoke model, and Threaded model. Hub and spoke model uses the Session Manager 200 to negotiate and select resources provided by various Resource Managers 202, 204, 206. The threaded model distributes the selection of resources into each Resource Manager by threading the signaling messages from Session Manager 200 to Edge Resource Manager 206, Encryption Resource Manager 204, and On Demand Resource Manager 202 and then in reverse order.

For NGOD Release 1, it is recommended to use the hub and spoke SRM model as primary SRM architecture. Threaded model description is provided in the SRM architecture specification as optional for extension in future release. All the interfaces for Release 1 are defined for the hub and spoke model. The threaded model description is included in the specification as informative or optional architecture.

3.3.2 Roles of Session Manger and Resource Manager

Session Manager is responsible for managing the life cycle of sessions. In the Hub and Spoke model, it negotiates and aggregates resources required for each session from the required Resource Managers. It maintains the persistence for all the active sessions and their associated resource requirements (bitrate, CA etc.) by interfacing with application components (e.g. Navigation Servers). Session manager should not have any knowledge of the underlying streaming resources, network topology, and edge devices, which are handled by corresponding Resource Managers.

Resource Managers allocate resources requested by Session Manager. They manage the resources associated with the underlying devices. They maintain the persistence for the resource availability of the devices they manage and active resources assigned to each session. Resource Managers shall not interface with any application components.

Session manager maintains the master list of active sessions and their resource requirement list. Resource manager maintains the master of inventory of resources and active list of resources for each device it manages. Streaming Servers and Edge Devices are the slaves of their resource managers for resource related information. Various fail-over and synchronization approaches can be provided based on the above architecture model

It is recommended to use a single identifier called OnDemandSessionID to identify session and its associated resources through out SRM components.

3.3.3 Selecting Edge Resource Manager

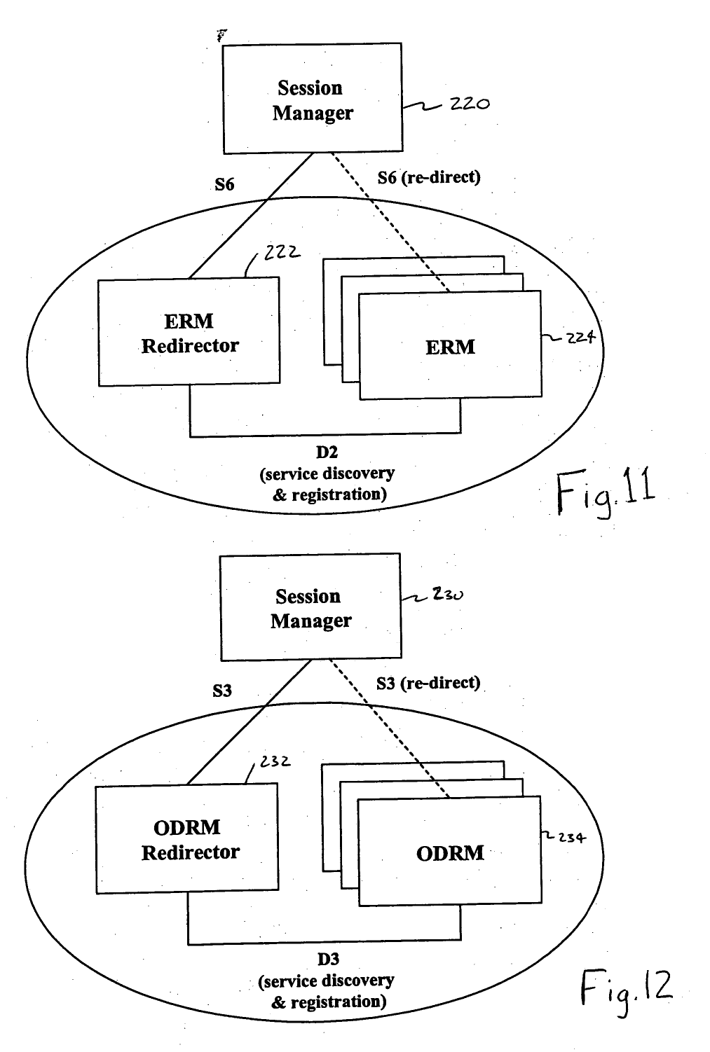

In order to determine how the Session Manager selects an Edge Resource Manager (ERM) for each session, it is recommended to allow Session Manager to interface with an ERM Redirector for selection of ERM. This is shown in FIG. 11, which shows Session Manager 220, ERM Redirector 222, and ERMs 224.

Given the earlier recommendation that a service group can only be managed by a single ERM, the following approach of selecting ERM can be used:
Session Managers 220 do not have to maintain the ERM resource domain and will pass along the relevant descriptor (e.g. QAM list descriptor) from client session message to the ERM Redirector 222.
The ERM Redirector 222 discovers the mapping between QAMs and, Edge Resource Manager from ERMs 224. A method is suggested for the ERM Redirector 222 to discover the ERM via the interface D2.
   ERMs 224 maintain and advertise the Service Group (e.g. QAM name) coverage
   ERM Redirector 222 discovers the mapping between ERM and service group (e.g. QAM name) from all the ERMs 224
   ERM Redirector 222 updates the mapping of service group and ERM if there are any changes of topology
ERM Redirector 222 will enable SM 220 to interface with the selected ERM via re-direct

It is important to note that ERM Redirector 222 does not manage resources. It does not need to maintain session state but simply re-direct the requested from SM 220 to the selected ERM.

In a typical physical implementation, the ERM Redirector 222 is implemented within the Session Manager 220. However, the interfaces of ERM Redirector 222 still need to be exposed in this case.

3.3.4 Selecting an On Demand Resource Manager

In order to determine how the Session Manager selects an On Demand Resource Manager (ODRM) for each session, it is recommended to allow Session Manager to interface with an ODRM Redirector for selection of ODRM. This is shown in FIG. 12, which shows Session Manager 230, ODRM Redirector 232, and ODRMs 234.

Given the earlier recommendation that assets can be located within the multiple ODRM and Streaming Server hierarchy that can serve the same service group, the following approach of selecting ODRM can be used:
Session Managers 230 do not have to maintain the ODRM topology and will pass along the asset related descriptor from the Purchase Server to the ODRM Redirector 232.
ODRM Redirector 232 selects a single ODRM 234 based on the asset availability and high level topology identified by address domain:
   ODRM Redirector 232 retrieves asset location in various ODRM 234 by interfacing with Asset Locator
   ODRM Redirector 232 retrieves high level topology of ODRM to the ERM domain. A method is suggested for the ODRM Redirector 232 to discover the ODRM via the interface D3.
   Various cost function can be used to select a single ODRM 234 by the ODRM Redirector 232. The attributes to the cost functions can be influenced by the load balancing, network connectivity status, and redundancy.
ODRM Redirector 232 will enable SM 230 to interface with the selected ODRM 234 via re-direct.

It is important to note that ODRM Redirector 232 does not manage resources. It does not need to maintain session state but simply re-direct the requested from SM 230 to the selected ODRM.

In a typical physical implementation, the ODRM Redirector 232 is implemented within the Session Manager 230. However, the interfaces of ODRM Redirector 232 still need to be exposed in this case.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for on demand session and resource management in an on demand platform for the delivery of on demand digital assets, the system comprising:
a session manager for managing on demand sessions;
a plurality of resource managers for managing resources associated with the on demand delivery of a digital asset to an on demand client during an on demand session;
a resource manager redirector between the session manager and the plurality of resource managers, the resource manager redirector interfacing, and redirecting messages from, the session manager to cause a redirected message to be routed to an appropriate resource manager;
wherein the session manager, the resource manager redirector, and the plurality of resource managers cooperate to form an architecture partitioned into logical components, each logical component interfacing with at least one other logical component through a defined interface, with the session manager being a separate logical component from the plurality of resource managers, the session manager and the plurality of resource managers cooperating to provide a distributed and scalable system for on demand session and resource management; and
wherein redirection of session and resource signaling messages among various session and resource managers by the resource manager redirector allows the unavailability of devices or resources to remain transparent to the session manager, with the resource manager redirector redirecting messages from the session manager as appropriate.

2. The system of claim 1 wherein the plurality of resource managers includes a plurality of edge resource managers that manage edge devices, wherein the resource manager redirector is an edge resource manager redirector that redirects messages from the session manager to the appropriate edge resource managers.

3. The system of claim 2 wherein the edge resource manager redirector is operative to discover the mappings between the edge devices and the edge resource managers, and to redirect messages to appropriate edge resource managers based on the mappings.

4. The system of claim 3 wherein the edge resource managers maintain and advertise service group coverage, and the edge resource manager redirector updates the discovered mappings as needed to reflect the current service group coverage.

5. The system of claim 1 wherein the plurality of resource managers includes a plurality of on demand resource managers that manage streaming servers, wherein the resource manager redirector is an on demand resource manager redirector that redirects messages from the session manager to the appropriate on demand resource managers.

6. The system of claim 5 wherein the on demand resource manager redirector is operative to determine suitable streaming servers for a requested digital asset.

7. The system of claim 6 wherein the on demand resource manager redirector is operative to retrieve a topology of an on demand resource manager domain to an edge resource manager domain.

8. The system of claim 7 wherein the on demand resource manager redirector utilizes a cost function to select an appropriate on demand resource manager out of available on demand resource managers that have access to a suitable streaming server and have suitable location in the topology.

9. A system for on demand session and resource management in an on demand platform for the delivery of on demand digital assets, the system comprising:
a session manager for managing on demand sessions;
a plurality of resource managers for managing resources associated with the on demand delivery of a digital asset to an on demand client during an on demand session, the plurality of resource managers including a plurality of edge resource managers that manage edge devices and including a plurality of on demand resource managers that manage streaming servers;
an edge resource manager redirector between the session manager and the plurality of edge resource managers, the edge resource manager redirector interfacing, and redirecting messages from, the session manager to cause a redirected message to be routed to an appropriate edge resource manager;
an on demand resource manager redirector between the session manager and the plurality of on demand resource managers, the on demand resource manager redirector interfacing, and redirecting messages from, the session manager to cause a redirected message to be routed to an appropriate on demand resource manager;
wherein the session manager, the resource manager redirectors, and the plurality of resource managers cooperate to form an architecture partitioned into logical components, each logical component interfacing with at least one other logical component through a defined interface, with the session manager being a separate logical component from the plurality of resource managers, the session manager and the plurality of resource managers cooperating to provide a distributed and scalable system for on demand session and resource management; and
wherein redirection of session and resource signaling messages among various session and resource managers by the resource manager redirectors allows the unavailability of devices or resources to remain transparent to the session manager, with the resource manager redirector redirecting messages from the session manager as appropriate.

10. The system of claim 9 wherein the edge resource manager redirector is operative to discover the mappings between the edge devices and the edge resource managers, and to redirect messages to appropriate edge resource managers based on the mappings.

11. The system of claim 10 wherein the edge resource managers maintain and advertise service group coverage, and the edge resource manager redirector updates the discovered mappings as needed to reflect the current service group coverage.

12. The system of claim 9 wherein the on demand resource manager redirector is operative to determine suitable streaming servers for a requested digital asset.

13. The system of claim 12 wherein the on demand resource manager redirector is operative to retrieve a topology of an on demand resource manager domain to an edge resource manager domain.

14. The system of claim 13 wherein the on demand resource manager redirector utilizes a cost function to select an appropriate on demand resource manager out of available on demand resource managers that have access to a suitable streaming server and have suitable location in the topology.
